(19) United States
(12) Patent Application Publication
(10) Pub. No.: US 2005/0159955 A1
(43) Pub. Date: Jul. 21, 2005

(54) Dialog control for an electric apparatus

(76) Inventor: Martin Oerder, Herzogenrath (DE)

Correspondence Address: PHILIPS INTELLECTUAL PROPERTY & STANDARDS, P.O. BOX 3001, BRIARCLIFF MANOR, NY, 10510, US

(21) Appl. No.: 10/513,945

(22) PCT Filed: May 9, 2003
(86) PCT No.: PCT/IB03/01816

(30) Foreign Application Priority Data
May 14, 2002 (DE) 10221490.5
Oct. 22, 2002 (DE) 10249060.0

(51) Int. Cl. G10L 11/00

(52) U.S. Cl. 704/273

(57) ABSTRACT

A device comprising means for picking up and recognizing speech signals and a method of controlling an electric apparatus are proposed. The device comprises a personifying element (14) which can be moved mechanically. The position of a user is determined and the personifying element (14), which may comprise, for example, the representation of a human face, is moved in such a way that its front side (44) points in the direction of the user's position. Microphones (16), loudspeakers (18) and/or a camera (20) may be arranged on the personifying element (14). The user can conduct a speech dialog with the device, in which the apparatus is represented in the form of the personifying element (14). An electric apparatus can be controlled in accordance with the user's speech input. A dialog of the user with the personifying element for the purpose of instructing the user is also possible.

The invention relates to a device comprising means for picking up and recognizing speech signals and to a method of communication by a user with an electronic apparatus.

Speech recognition means are known with which picked-up acoustic speech signals can be assigned to the corresponding word or a corresponding sequence of words. Speech recognition systems are often used as dialog systems in combination with speech synthesis for controlling electric apparatuses. A dialog with the user may be used as the sole interface for operating the electric apparatus. It is also possible to use the speech input and possibly also output as one of a plurality of communication means.

U.S. Pat. No. 6,118,888 describes a control device and a method of controlling an electric apparatus, for example, a computer, or an apparatus used in the field of entertainment electronics. For controlling the apparatus, the user has the disposal of a plurality of input facilities. These are mechanical input facilities such as a keyboard or a mouse, as well as speech recognition. Moreover, the control device comprises a camera with which the gesticulations and mimicry of the user can be picked up and which are processed as further input signals. The communication with the user is realized in the form of a dialog, in which the system has a plurality of modes at its disposal for transferring information to the user. It comprises speech synthesis and speech output. Particularly, it also comprises an anthropomorphic representation, for example, of a person, a human face or an animal. This representation is shown to the user in the form of a computer graph on a display screen.

While dialog systems are already used these days in special applications, for example, in telephone information systems, their acceptance in other fields, for example, controlling electric apparatuses within the domestic sphere, entertainment electronics, is still insignificant.

It is an object of the invention to provide a device comprising pick-up means for recognizing speech signals, and a method of operating an electronic apparatus which enables a user to easily operate the device by means of speech control.

This object is solved by a device as defined in claim 1 and a method as defined in claim 11. Dependent claims define advantageous embodiments of the invention.

The device according to the invention comprises a mechanically movable personifying element. This is a part of the device which serves as a personification of a dialog partner for the user. The concrete implementation of such a personifying element may be quite different. For example, it may be a part of a housing which can be moved by means of a motor with respect to a stationary housing of an electric device. It is essential that the personifying element has a front side which can be recognized as such by the user. If this front side faces the user, he will get the impression that the device is “attentive”, i.e. it can receive speech commands.

According to the invention, the device comprises means for determining the position of a user. This can be realized, for example, via acoustic or optical sensors. The motion means for the personifying element are controlled in such a way that the front side of the personifying element is directed towards the user's position. This gives the user the constant impression that the device is ready to “listen” to him.

In accordance with a further embodiment of the invention, the personifying element comprises an anthropomorphic representation. This may be a representation of a person or an animal, but also of a fantasy figure, for example, a robot. A representation of a human face is preferred. It may be a realistic or only symbolic representation in which, for example, only the circumferences such as eyes, nose and mouth are shown.

The device preferably also comprises means for supplying speech signals. It is true that particularly the speech recognition is essential for the control of an electronic apparatus. Replies, confirmations, inquiries etc. may, however, be realized with speech output means. They may comprise the reproduction of pre-stored speech signals as well as real speech synthesis. A complete dialog control may be realized with speech output means. Dialogs can also be conducted with the user for the purpose of entertaining him.

According to a further embodiment of the invention, the device comprises a plurality of microphones and/or at least one camera. Speech signals can already be picked up with a single microphone. However, when using a plurality of microphones, a pick-up pattern can be achieved, on the one hand. On the other hand, the position of the user can also be found by receiving the speech signal from a user via a plurality of microphones. The environment of the device can be observed with a camera. By corresponding image processing, the position of the user can also be determined from the picked-up image. The microphones, the camera and/or loudspeakers for supplying speech signals may be arranged on the mechanically movable personifying element. For example, for a personifying element in the form of a human head, two cameras may be arranged within the area of the eyes, a loudspeaker at the position of the mouth and two microphones near the ears.

It is preferred that means for identifying a user are provided. This may be achieved, for example, by evaluation of a picked-up image signal (visual, or face recognition) or by evaluating the picked-up acoustic signal (speech recognition). The device can thereby determine the current user from a number of persons in the environment of the device and direct the personifying element onto this user.

There are widely various possibilities of implementing the motion means for mechanically moving the personifying element. For example, these means may be electromotors or hydraulic adjusting means. The personifying element may also be moved by the motion means. It is, however, preferred that the personifying element is only swivable with respect to a stationary part. For example, swiveling movements around a horizontal and/or vertical shaft are possible in this case.

The device according to the invention may form part of an electric apparatus such as apparatus for entertainment electronics (for example, TV, playback devices for audio and/or video, etc.). In this case, the device represents the user interface for the apparatus. Moreover, the apparatus may also comprise other operating means (keyboard, etc.). Alternatively, the device according to the invention may be an independent apparatus which serves as a control device for controlling one or more separate electric apparatuses. In this case, the devices to be controlled have an electric control terminal (for example, wireless terminal or a suitable control bus) via which the device controls the apparatuses in accordance with the speech commands received from the user.

The device according to the invention may particularly serve for the user as an interface of a system for data storage and/or inquiry. For this purpose, the device comprises internal data memories, or the device is connected to an external data memory, for example, via a computer network or the Internet. In the dialog, the user may store data (for example, telephone numbers, memos, etc.) or request data (for example, time, news, the current television program etc.).

Moreover, the dialogs with the user can also be used to adjust parameters of the device itself and change their configuration.

When a loudspeaker for the supply of acoustic signals and a microphone for picking up these signals are provided, a signal processing with interference suppression may be provided, i.e. the picked-up acoustic signals are processed in such a way that parts of the acoustic signal coming from the loudspeaker are suppressed. This is particularly advantageous when the loudspeaker and microphone are arranged in spatial proximity, for example, on the personifying element.

In addition to the above-mentioned use of the device for controlling an electric apparatus, it may also be used for conducting a dialog with the user, serving other purposes such as, for example, information, entertainment or instruction for the user. According to a further embodiment of the invention, dialog means are provided with which a dialog can be conducted for instructing the user. The dialog is then preferably conducted in such a way that the user is given instructions and his answers are picked up. The instructions may be complex questions, but it is preferred to ask questions about short learning objects such as, for example, vocabulary of a foreign language, in which the instruction (for example definition of a word) and answer (for example the word in the foreign language) are relatively short. The dialog is conducted by the user with the personifying element and may be effected visually and/or by audio.

A possibly effective learning method is proposed in that a set of learning objects (for example, vocabulary of a foreign language) is stored, in which, for each learning object, at least one question is stored (for example, definition), a solution (for example, vocabulary) and a measure of the period of time since the last question to the user or the correct solution of the question by this user. During the dialog, learning objects are selected and asked one after the other, in which the question is asked to the user and the user's answer is compared with the stored solution. The selection of the learning object to be asked questions about takes the stored measure, i.e. the time elapsed since the last question about the object, into account. This may be realized, for example, via a suitable learning model with an assumed or determined error rate. Additionally, each learning object may also be evaluated with a relevance measure which is taken into account in the selection, in addition to the time measure.

These and other aspects of the invention are apparent from and will be elucidated with reference to the embodiments described hereinafter.

In the drawings:

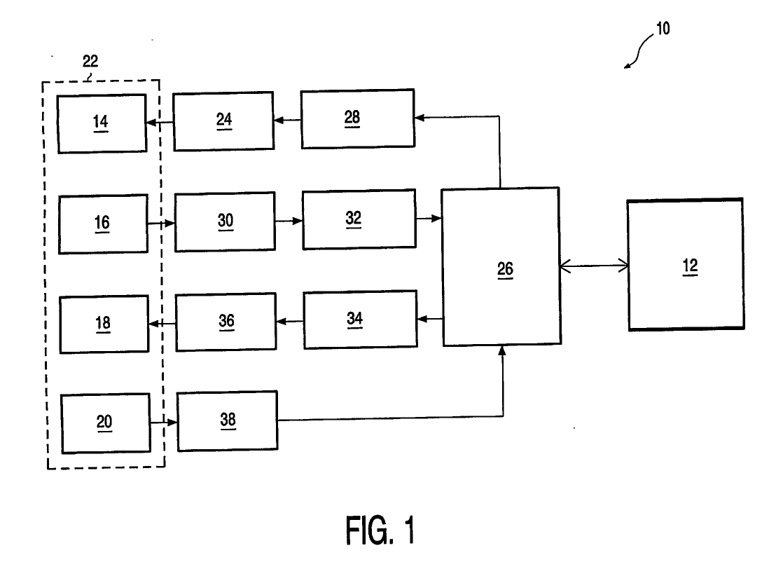

FIG. 1 is a block diagram of elements of a control device;

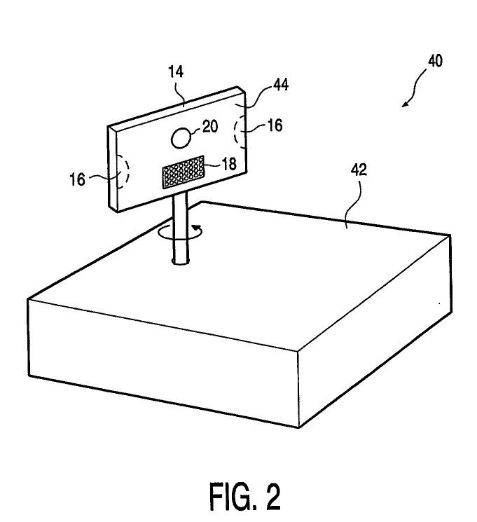

FIG. 2 is a perspective view of an electronic apparatus comprising a control device.

FIG. 1 is a block diagram of a control device 10 and an apparatus 12 controlled by this device. The control device 10 is in the form of a personifying element 14 for the user. A microphone 16, a loudspeaker 18 and a position sensor, here in the form a camera 20, for a user's position are arranged on the personifying element 14. These elements jointly constitute a mechanical unit 22. The personifying element 14 and hence the mechanical unit 22 are swiveled about a vertical shaft by a motor 24. A central control unit 26 controls the motor 24 via a drive circuit 28. The personifying element 24 is an independent mechanical unit. It has a front side which can be recognized as such by the user. Microphone 16, loudspeaker 18 and camera 20 are arranged on the personifying element 14 in the direction of this front side.

The microphone 16 supplies an acoustic signal. This signal is picked up by a pick-up system 30 and processed by a speech recognition unit 32. The speech recognition result, i.e. the word sequence assigned to the picked-up acoustic signal is passed on to the central control unit 26.

The central control unit 26 also controls a speech synthesis unit 34 which supplies a synthetic speech signal via a sound-generating unit 36 and the loudspeaker 18.

The image picked up by the camera 20 is processed by the image processing unit 38. The image processing unit 38 determines the position of a user from the image signal supplied by the camera 20. The position information is passed on to the central control unit 26.

The mechanical unit 22 serves as a user interface via which the central control unit 26 receives inputs from the user (microphone 16, speech recognition unit 32) and reports back to the user (speech synthesis unit 34, loudspeaker 18). In this case, the control unit 10 is used for controlling an electric apparatus 12, for example, an apparatus used in the field of entertainment electronics.

The functional units of the control device 10 are shown only symbolically in FIG. 1. The different units, for example, central control unit 26, speech recognition unit 32, image processing unit 38 may be present as separate groups in a concrete transformation. Likewise, a purely software implementation of these units is feasible, in which the functionality of a plurality or all of these units is realized by a program run on a central unit.

It is neither obligatory that these units are in a spatial proximity to each other or to the mechanical unit 22. The mechanical unit 22, i.e. the personifying element 14 as well as the units of microphone 16, loudspeaker 18 and sensor 20, which are preferably but not necessarily arranged on this element, may be arranged separately from the rest of the control device 10 and only have a signal connection therewith via lines or a wireless connection.

In operation, the control device 10 constantly ascertains whether a user is in its proximity. The user's position is determined. The central control unit 26 controls the motor 24 in such a way that the front side of the personifying element 10 is directed towards the user.

The image processing unit 38 also comprises face recognition. When the camera 20 supplies an image of a plurality of persons, it is determined by means of face recognition which person is the user that is known to the system. The personifying element 14 is directed towards this user. When a plurality of microphones is provided, the signals from these microphones can be processed in such a way that a pick-up pattern in the direction of the known position of the user is obtained.

The image processing unit 38 may additionally be implemented in such a way that it “understands” the scene, picked up by the camera 20, in the vicinity of the mechanical unit 22. The relevant scene can then be assigned to a number of predefined states. For example, in this manner, it is known to the central control unit 26 whether there are one or more persons in the room. The unit may also recognize and assign the user's behavior, i.e., for example, whether the user is looking in the direction of the mechanical unit 22 or whether he is speaking to another person. By evaluating the states thus recognized, the recognition capacity can be clearly improved. For example, it can be avoided that parts of a conversation between two persons are erroneously interpreted as speech commands.

In a dialog with the user, the central control unit determines input and controls the apparatus 12 accordingly. Such a dialog for controlling the sound volume of an audio reproduction apparatus 12 may proceed, for example, as follows:
the user changes his position and faces the personifying element 14. The personifying element 14 is constantly directed by the motor 24 in such a way that its front side faces the user. For this purpose, the drive circuit 28 is controlled by the central control unit 26 of the apparatus 10 in accordance with the determined position of the user;
the user gives a speech command, for example, “TV volume”. The speech command is picked up by the microphone 16 and recognized by the speech recognition unit
the central control unit 26 reacts by means of a question: “Higher or lower?” from the loudspeaker 18 via the speech synthesis unit 34;
the user gives the speech command “lower”. After recognition of the speech signal, the central control unit 26 controls the apparatus 12 in such a way that the volume is reduced.

FIG. 2 is a perspective view of an electronic apparatus 40 with an integrated control device. Only the personifying element 14 of the control device 10 can be seen in this Figure, which element can be swiveled about a vertical shaft with respect to a stationary housing 42 of the apparatus 40. In this example, the personifying element has a flat, rectangular shape. The objective of the camera 20 as well as the loudspeaker 18 is present on the front side 44. Two microphones 16 are arranged on the sides. The mechanical unit 22 is rotated by a motor (not shown) in such a way that the front side always points in the direction of the user.

In one embodiment (not shown) the device 10 of FIG. 1 is not used for controlling the apparatus 12 but for conducting a dialog with the object of instructing a user. The central control unit 26 performs a learning program with which the user can learn a foreign language. A set of learning objects is stored in a memory. These are individual sets of data, each of which indicates the definition of a word, the corresponding word in the foreign language, an evaluation measure for the relevance of the word (frequency of occurrence of the word in the language) and a time measure for the duration of the time elapsed since the last question in the data record.

A learning unit in the dialog is now run in that data records are selected and asked one after the other. In this case, the user is given an instruction, i.e. the definition stored in the data record is optically indicated or supplied acoustically. The user's answer, for example, entered by means of a keyboard, and preferably picked up via the microphone 16 and the automatic speech recognition 32 is picked up and stored with the stored solution (vocabulary). The user is informed whether the solution was recognized as a correct solution. In the case of erroneous answers, the user may be informed of the correct solution or may once or several times be given the opportunity to give further answers. After the data record has been processed in this way, the stored measure for the duration of time since the last question is updated, i.e. set to zero.

Subsequently, a further data record, etc., is selected and queried.

The selection of the data record to be queried is realized by means of a memory model. A simple memory model is represented by the formula
P(k)=exp(−t(k)*r(c(k))),
in which P(k) denotes the probability that the learning object k is known, exp denotes the exponential function, t(k) denotes the time since the object was queried last, c(k) denotes the learning class of the object and r(c(k)) is the learning class-specific error rate. The time may be used for t. The time t may also be given in learning steps. Learning classes can be defined in different suitable ways. A possible model is to assign a relevant class for each N>0 of all objects which were answered correctly N times. For the error rate, a suitable fixed value can be assumed, or a suitable starting value can be selected and, for example, adapted by means of a gradient algorithm.

The object of the instruction is a maximization of a measure of knowledge. This measure of knowledge is defined as the part of the learning object of the set, known to the user, and is weighted with the relevance measure. Since the question about an object k brings the probability P(k) to one, it is proposed for optimization of the measure of knowledge that, in each step, the object having the lowest knowledge probability P(k), possibly weighted with the relevance measure U(k), U(k)*1−P(k), is queried. By way of the model, the measure of knowledge can be computed after each step and indicated to the user. The method is optimized so as to give the user a possibly broad knowledge of the learning object of the current set. By using a good memory model, an effective learning strategy is achieved in this way.

A plurality of modifications and further improvements are feasible for the query dialog described above. For example, one question (definition) may have a plurality of correct answers (vocabulary). This can be taken into account, for example, by using the stored relevance measures and thus accentuating the more relevant (more frequent) words. The relevant sets of learning objects may comprise, for example, a few thousand words. These may be, for example, learning objects, i.e. specific vocabulary for given uses, for example, in the field of literature, business, technique, etc.

In summary, the invention relates to a device comprising means for picking up and recognizing speech signals, and a method of communicating with an electric apparatus. The device comprises a personifying element which can be moved mechanically. The position of a user is determined and the personifying element, which may comprise, for example, the representation of a human face, is moved in such a way that its front side points in the direction of the user's position. Microphones, loudspeakers and/or a camera may be arranged on the personifying element. The user can conduct a speech dialog with the device, in which the apparatus is represented in the form of the personifying element. An electric apparatus can be controlled in accordance with the user's speech input. A dialog of the user with the personifying element for the purpose of instructing the user is also possible.

1. A device comprising:
means for picking up and recognizing speech signals (30, 32); and
a personifying element (14) having a front side (44), and motion means (24) for mechanically moving the personifying element (14), wherein:
means (38) for determining the position of a user are provided; and
the motion means (24) are controlled in such a way that the front side (44) of the personifying element (14) points in the direction of the user's position.

2. A device as claimed in claim 1, wherein means (34, 36, 18) for supplying speech signals are provided.

3. A device as claimed in claim 1, wherein the personifying element (14) comprises an anthropomorphic representation, particularly a representation of a human face.

4. A device as claimed in claim 1, wherein:
a plurality of microphones (16) and/or at least one camera (20) are provided;
the microphones (16) and/or the camera (20) being preferably arranged on the personifying element (14).

5. A device as claimed in claim 1, wherein means for identifying at least one user are provided.

6. A device as claimed in claim 1, wherein the motion means (24) provide the possibility of swiveling the personifying element (14) about at least one shaft.

7. A device as claimed in claim 1, wherein at least one external electric apparatus (12) is provided, which is controlled by the speech signals.

8. A device as claimed in claim 1, wherein:
at least one loudspeaker (8) is provided for supplying acoustic signals; and
at least one microphone (16) is provided for picking up acoustic signals; and wherein
a signal processing unit (30) for processing the picked-up acoustic signals is provided, in which parts of the signal originating from acoustic signals emitted by the loudspeaker (18) are suppressed.

9. A device as claimed in claim 1, wherein means for conducting a dialog for the purpose of instructing a user are provided, which dialog the user is given instructions in a visual way and/or by means of audio, and the user's answers are picked up by means of a keyboard and/or a microphone.

10. A device as claimed in claim 9, wherein the dialog means comprise storage means for a set of learning objects, wherein:
at least one instruction, one solution and one measure of the duration since the instruction was processed by the user is stored for each learning object; and
the dialog means are formed in such a way that learning objects can be selected and queried by giving the user the instruction and comparing the user's answer with the stored solution; and wherein
the stored measure is taken into account in the selection of the learning objects.

11. A method of communication between a user and an electric apparatus (12), wherein:
a user's position is determined;
a personifying element (14) is moved in such a way that a front side (44) of the personifying element (14) points in the direction of the user; and
speech signals from the user are picked up and processed.

12. A method as claimed in claim 11, wherein the electric apparatus (12) is controlled in accordance with the picked-up speech signals.
